(19) United States
(12) Patent Application Publication
(10) Pub. No.: US 2013/0089057 A1
(43) Pub. Date: Apr. 11, 2013

(54) METHOD AND DEVICE FOR DELIVERY OF BSR INFORMATION TO ASSIST EFFICIENT SCHEDULING

(71) Applicants: Chandrika Worrall, Newbury (GB); Pingping Wen, PuDong Jinqiao Shanghai (CN)

(72) Inventors: Chandrika Worrall, Newbury (GB); Pingping Wen, PuDong Jinqiao Shanghai (CN)

(73) Assignee: ALCATEL LUCENT, Paris (FR)

(21) Appl. No.: 13/703,478

(22) PCT Filed: Jun. 21, 2010
(86) PCT No.: PCT/CN2010/074176

§ 371 Date: Dec. 11, 2012

(51) Int. Cl. H04W 24/10

(52) U.S. Cl. CPC H04W 24/10
USPC 370/329; 370/328

(57) ABSTRACT

The invention proposes the method and device for delivery BSR information to assist efficient scheduling. It introduces at least one additional table (also called extended table) which indicates the buffer statues corresponding to the higher data rates than the existing table. The use of the at least one additional table is identified by new identification(s), more specifically one or more Logical channel ID. The signaling uses MAC layer signaling as in ReI.8/9. In an embodiment of the present invention, the new MAC CE is designed to guarantee the co-existence of ReI.8/9 and ReI.10 buffer status reporting depending on low or high data rates.

### FIELD OF THE INVENTION

The invention relates to the eNodeB and UE in the field of wireless telecommunication, and particular to the method and device for delivery BSR information to assist efficient scheduling.

### BACKGROUND OF THE INVENTION

With the introduction of carrier aggregation (CA) in Long Term Evolution-Advanced (LTE-Advanced or LTE-A, Rel.10), there are multiple Media Access Control Packet Data Units (MAC PDUs) in one Transport Time Interval (TTI) compared with only one MAC PDU supported in the Rel. 8/9 (LTE), as a result Rel.10 User Equipments (UEs) will be able to support very large data throughput.

Buffer Status Reports (BSRs) from the UE to the eNodeB are used to assist the eNodeB's allocation of uplink radio resources. The basic assumption underlying scheduling in LTE is that radio resources are only allocated for transmission to or from a UE if data is available to be sent or received. In the downlink direction, the scheduler in the eNodeB is obviously aware of the amount of data to be delivered to each UE; however, in the uplink direction, because the scheduling decisions are performed in the eNodeB and the buffer for the data is located in the UE, BSRs have to be sent from the UE to the eNodeB to indicate the amount of data in the UE that needs to be transmitted over the UL-SCH.

Two types of BSR are defined in LTE: a long BSR and a short BSR; which one is transmitted depends on the amount of available uplink transmission resources for sending the BSR, on how many logical channels groups (LCGs) have non-empty buffers, and on whether a specific event is triggered at the UE. The long BSR reports the amount of data for four logical channel groups, whereas the short BSR reports the amount of data for only one logical channel group. Although the UE might actually have more than four logical channels configured, the overhead would be large if the amount of data in the UE were to be reported for every logical channel individually. Thus, grouping the logical channels into four groups for reporting purposes represents a compromise between efficiency and accuracy.

The BSR contains the amount of data waiting in the UE buffer and it is transmitted using MAC layer signaling (MAC CE or MAC Control Element). Maximum buffer size allowable, i.e., 150000 Bytes in Rel.8/9 reporting is not sufficient to signal higher data rate hence it is not possible to inform the eNodeB of the UE buffer size accurately with the use of Rel.8/9 method.

### SUMMARY OF THE INVENTION

Therefore, it is necessary to design a method and corresponding system where the higher data rate can be informed to the eNodeB. However, the design should also guarantee the backward compatibility of Rel.8/9 method as Rel.8/9 UEs will also present together with Rel.10 UEs in a Rel.10 network.

As the backward compatibility needs to be respected, the invention introduces at least one additional table (also called extended table) which indicates the buffer statues corresponding to the higher data rates than the existing table (also Rel. 8/9 table, for example the following Table 2: Buffer size levels for BSR). The use of the at least one additional table is identified by new identification(s), more specifically one or more Logical channel ID (LCID for short). The signaling uses MAC layer signaling as in Rel.8/9. In an embodiment of the present invention, the new MAC CE is designed to guarantee the co-existence of Rel.8/9 and Rel.10 buffer status reporting depending on low or high data rates.

The information of buffer status is provided to the eNodeB by using either one or two MAC CEs. If one MAC CE is sufficient for signaling of BSR, the LCID used in the MAC CE header indicates which BSR table has been used (either Rel.8/9 BSR table or the additional BSR table(s)). If two MAC CEs are needed for the signaling of BSR, the data within the first MAC CE content indicates the transmission of the second MAC CE.

According to one aspect of the present invention, there is provided a method in a UE of reporting BSR to an eNodeB dominating said UE comprising: A. determining whether BSR for at least one LCG with larger buffer size needs at least one additional table to be reported, said LCG with higher buffer size having a buffer size larger than a predetermined value; B. if the BSR for said at least one LCG with larger buffer size needs to be reported, generating the BSR for said at least one LCG with higher buffer size with an index referring to said at least one additional table, said at least one additional table indicating the buffer status corresponding to higher data rates than Rel. 8/9 table; C. reporting is said generated BSR to said eNodeB.

According to a second aspect of the present invention, there is provided a method in an eNodeB dominating a UE of processing BSR from said UE comprising: I. receiving BSR from said UE; II. determining whether said received BSR is the BSR for at least one LCG with larger buffer size according to the LCID derived from said received BSR, said LCG with larger buffer size having a buffer size larger than a predetermined value; III. if said BSR for at least one LCG with larger buffer size is used, obtaining the buffer size according to said BSR and at least one additional table, and scheduling UL resources for said UE according to said buffer size, said at least one additional table indicating the buffer status corresponding to higher data rates than Rel. 8/9 table.

The present invention enables the transmission of more accurate buffer status for high data rates, therefore improves the scheduler efficiency. According to some preferred embodiments, the signaling overhead on air interface is reduced.

### DESCRIPTION OF DRAWINGS

Other features, aspects and advantages of the present invention will become obvious by reading the following description of non-limiting embodiments with reference to the appended drawings.

FIG. 1A shows the Rel. 8/9 short BSR and truncated BSR MAC control element;

FIG. 1B shows the long BSR MAC control element;

FIG. 1C shows the R/R/E/LCID MAC sub-header;

FIGS. 2A, 2B and 2C show the BSR report with additional table, wherein, FIG. 2A shows long BSR as same as Rel.8/9 format, FIG. 2B shows short BSR using additional BSR table for LCG#1, and FIG. 2C shows short BSR using additional BSR table for LCG#2;

FIG. 3 shows the use of additional Long BSR table;

FIGS. 4A and 4B show the use of extended long BSR and Rel. 8/9 short BSR, wherein, FIG. 4A shows the use of additional long BSR table and FIG. 4B shows the short BSR as same as Rel. 8/9 format;

FIG. 5 shows the user of new format for BSR;

FIG. 6 shows the L field indicating the length of the variable BSR MAC CE in bytes;

FIG. 7 shows that the first two bits in MAC CE content is used to indicate the BSR table;

FIG. 8 shows the use of another new format for BSR;

FIG. 9 shows a network topology of the present invention;

FIG. 10 shows a systematic flowchart of a method according to an embodiment of the present invention;

FIG. 11 shows a block diagram for the device according to an embodiment of the present invention.

Wherein, same or similar reference numerals refer to the same or similar steps or means.

### DETAILED EMBODIMENTS OF THE INVENTION

The illustrative description of the embodiments of the present invention will be given in details combined with the appended figures.

In LTE Rel.8/9, buffer status is measured at LCGs. There are up to four LCGs defined.

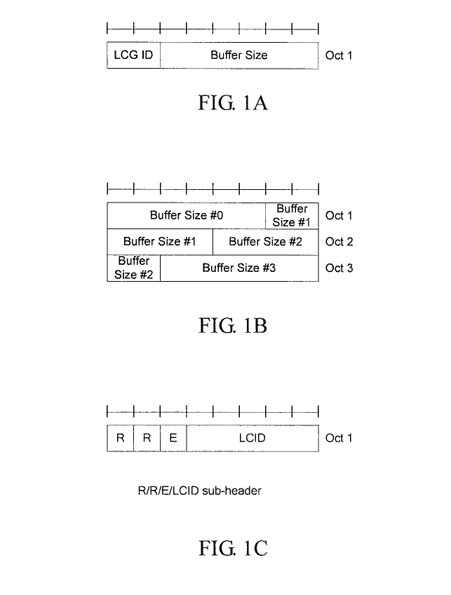

Buffer Status Report (BSR) MAC control elements consist of either:
Short BSR and Truncated BSR format: one LCG ID field and one corresponding Buffer Size field as shown in FIG. 1A; or
Long BSR format: four Buffer Size fields, corresponding to LCG IDs #0 through #3 as shown in FIG. 1B.

If the number of logical channel groups is active and there is need for transmitting BSR for all of the LCGs, long BSR is used. If BSR for just one LCG is to be transmitted, short BSR is used.

The fields LCG ID and Buffer Size shown in FIGS. 1A and 1B are defined as follow:
LCG ID: The Logical Channel Group ID field identifies the group of logical channel(s) which buffer status is being reported. The length of the field is 2 bits, and when long BSR is sent, the LCG ID is not included in the MAC control element, instead, the order of the BSR within the MAC Control Element defines the LCG; If short BSR is sent, the LCG ID is included in the content of the MAC CE to identify the LCG;
Buffer Size: The Buffer Size field identifies the total amount of data available across all logical channels of a logical channel group after the MAC PDU has been built. The amount of data is indicated in number of bytes. It shall include all data that is available for transmission in the RLC layer and in the PDCP layer. The length of this field is 6 bits. The values taken by the Buffer Size field are shown in Table 2.

The BSR formats are identified by MAC PDU sub-headers with LCIDs as specified in table 1.

TABLE 1
Values of LCID for UL-SCH

| Index | LCID values |
|---|---|
| 00000 | CCCH |
| 00001-01010 | Identity of the logical channel |
| 01011-11001 | Reserved |
| 11010 | Power Headroom Report |
| 11011 | C-RNTI |
| 11100 | Truncated BSR |
| 11101 | Short BSR |
| 11110 | Long BSR |
| 11111 | Padding |

A MAC PDU header consists of one or more MAC PDU sub-headers; each sub-header corresponds to a MAC SDU, a MAC control element or padding.

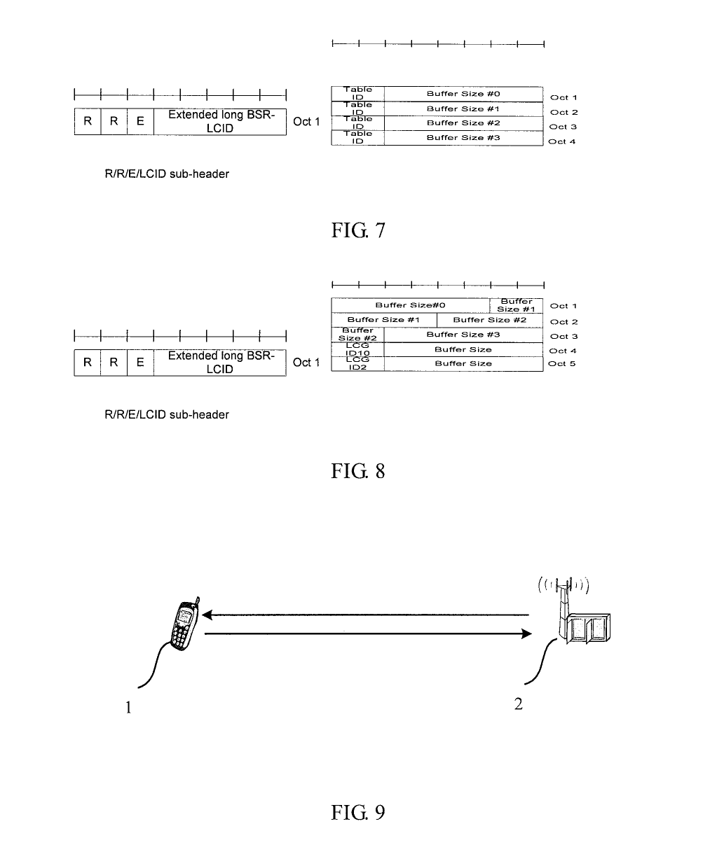

The MAC header is of variable size and consists of the following fields:
LCID: The Logical Channel ID field identifies the logical channel instance of the corresponding MAC SDU or the type of the corresponding MAC control element or padding as described in table 1 for UL-SCH. There is one LCID field for each MAC SDU, MAC control element or padding included in the MAC PDU. The LCID field size is 5 bits;
L: The Length field indicates the length of the corresponding MAC SDU in bytes, also refer to FIG. 7. There is one L field per MAC PDU sub-header except for the last sub-header and sub-headers corresponding to fixed-sized MAC control elements. The size of the L field is indicated by the F field;
F: The Format field indicates the size of the Length field. There is one F field per MAC PDU sub-header except for the last sub-header and sub-headers corresponding to fixed-sized MAC control elements. The size of the F field is 1 bit. If the size of the MAC SDU or variable-sized MAC control element is less than 128 bytes, the value of the F field is set to 0, otherwise it is set to 1;
E: The Extension field is a flag indicating if more fields are present in the MAC header or not. The E field is set to “1” to indicate another set of at least R/R/E/LCID fields. The E field is set to “0” to indicate that either a MAC SDU, a MAC control element or padding starts at the next byte;
R: Reserved bit, set to “0”.

A MAC PDU sub-header consists of the six header fields R/R/E/LCID/F/L but for the last sub-header in the MAC PDU and for fixed sized MAC control elements. The last sub-header in the MAC PDU and sub-headers for fixed sized MAC control elements consist solely of the four header fields R/R/E/LCID. A MAC PDU sub-header corresponding to padding consists of the four header fields R/R/E/LCID.

Table 2 illustrates the BSR table used in Rel.8/9. The table index is signaled in the BSR MAC CE, where 6 bit is used for the BSR index. The index 63 of the table indicate buffer status is larger than 150000 Bytes but no granular representation of the buffer sizes for the buffer corresponding to data rates higher than 150000 Bytes is given.

In this invention, it is assumed that up to four LCGs are used in Rel. 10, which is the same as in Rel.8/9. Also 6-bit indicator is used for the Rel. 8/9 BSR index. Additional table(s) could provide more granular BSR information for the higher rate to the scheduler. It is assumed that additional BSR table(s) will be used in parallel to the Rel.8/9 BSR table. Number of table(s) required for signaling of higher bit rate depends on the required granularity of the higher BSR values. The maximum allowed UL data rates for LTE-A has increased by factor of 6-7 compared to that of Rel.8/9 UL data rates (i.e. 500 Mbps UL rate is for LTE-A while 75 Mbps rate is for LTE). It is logical to assume that the increase of the maximum buffer size for LTE-A is proportional to the increase rate of UL bit rate. One or few additional tables are assumed to be required for signaling of high data rates. Additional table(s) is used for data above 150000 Bytes, i.e. index 0 of the first additional table is corresponding to the BS<150000 bytes. The number of additional table required is defined by the granularity of BS reporting. In the examples below it is assumed that only one additional table is sufficient, however, those skilled in the art can understand that a plurality of additional tables can be used if the granularity of BSR requires multiple additional tables for representation, and different additional tables used simultaneously are with their own unique extended BSR Table IDs. Rel.8/9 BSR table and reporting format are used in parallel with the additional table. A new extended LCID is used to indicate the extended table. The new extended LCID should use the reserved values which are different from the values already used in the above Table. 1.

FIG. 9 shows a network topology of the present invention. In FIG. 9, the UE 1 is dominated by eNodeB 2, and the UE 1 reports its buffer status to the eNodeB 2, so that the scheduler in the eNodeB 2 can schedule the uplink transmission resources for the UE 1 according to the buffer status reported by the eNodeB 2.

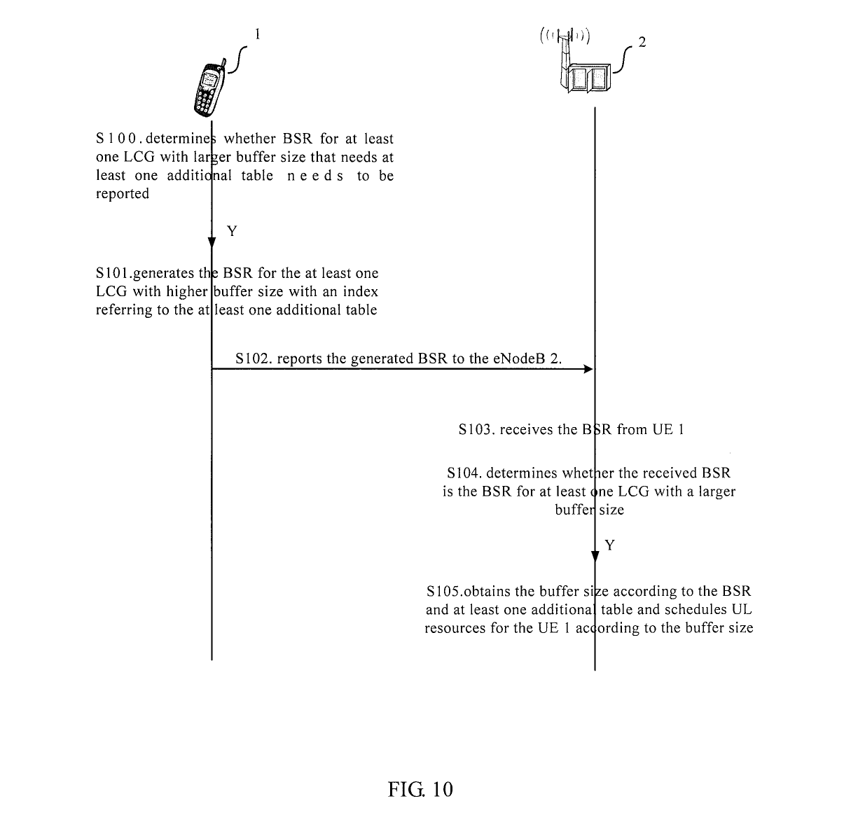

FIG. 10 shows a systematic flowchart of a method according to an embodiment of the present invention.

First, in step S100, the UE 1 determines whether BSR for at least one LCG with larger buffer size needs at least one additional table to be reported, and the LCG with higher buffer size has a buffer size larger than a predetermined value.

The UE 1 measures the buffer sizes of the logical channel groups that need to be reported, and determines whether at least one LCG with larger buffer size needs at least one additional table to be reported. Those skilled in the art can understand that since it has already been regulated in LTE Rel. 8/9 that the biggest index 63 of the buffer size levels for BSR in the Rel. 8/9 represent BS>150000, the predetermined value for the first additional table can be set to 150000. Of course, the predetermined value for the second or other additional table(s) if needed can be set by the telecommunication network operators and service provider based on the actual UL data rate of the UE. Such additional table(s) is used to provide not only more accurate granularity, but also higher data amount.

Then, in step S101, if the BSR for at least one LCG with larger buffer size needs to be reported, the UE 1 generates the BSR for the at least one LCG with higher buffer size with an index referring to the at least one additional table, and the at least one additional table indicates the buffer status corresponding to higher data rates than Rel. 8/9 table. The details of step S101 are described below with the following examples.

In this invention, only the existing Rel. 8/9 BSR table is shown in Table 2, and the additional BSR table(s) is not shown. However, those skilled in the art can understand that the specific design, for example, value and mapping relationship, of the additional BSR table is irrelevant to the core idea of the present invention thus is omitted for simplicity.

TABLE 2
Buffer size levels for BSR

| Index | Buffer Size (BS) value [bytes] |
|---|---|
| 0 | BS = 0 |
| 1 | 0 < BS <= 10 |
| 2 | 10 < BS <= 12 |
| 3 | 12 < BS <= 14 |
| 4 | 14 < BS <= 17 |
| 5 | 17 < BS <= 19 |
| 6 | 19 < BS <= 22 |
| 7 | 22 < BS <= 26 |
| 8 | 26 < BS <= 31 |
| 9 | 31 < BS <= 36 |
| 10 | 36 < BS <= 42 |
| 11 | 42 < BS <= 49 |
| 12 | 49 < BS <= 57 |
| 13 | 57 < BS <= 67 |
| 14 | 67 < BS <= 78 |
| 15 | 78 < BS <= 91 |
| 16 | 91 < BS <= 107 |
| 17 | 107 < BS <= 125 |
| 18 | 125 < BS <= 146 |
| 19 | 146 < BS <= 171 |
| 20 | 171 < BS <= 200 |
| 21 | 200 < BS <= 234 |
| 22 | 234 < BS <= 274 |
| 23 | 274 < BS <= 321 |
| 24 | 321 < BS <= 376 |
| 25 | 376 < BS <= 440 |
| 26 | 440 < BS <= 515 |
| 27 | 515 < BS <= 603 |
| 28 | 603 < BS <= 706 |
| 29 | 706 < BS <= 826 |
| 30 | 826 < BS <= 967 |
| 31 | 967 < BS <= 1132 |
| 32 | 1132 < BS <= 1326 |
| 33 | 1326 < BS <= 1552 |
| 34 | 1552 < BS <= 1817 |
| 35 | 1817 < BS <= 2127 |
| 36 | 2127 < BS <= 2490 |
| 37 | 2490 < BS <= 2915 |
| 38 | 2915 < BS <= 3413 |
| 39 | 3413 < BS <= 3995 |
| 40 | 3995 < BS <= 4677 |
| 41 | 4677 < BS <= 5476 |
| 42 | 5476 < BS <= 6411 |
| 43 | 6411 < BS <= 7505 |
| 44 | 7505 < BS <= 8787 |
| 45 | 8787 < BS <= 10287 |
| 46 | 10287 < BS <= 12043 |
| 47 | 12043 < BS <= 14099 |
| 48 | 14099 < BS <= 16507 |
| 49 | 16507 < BS <= 19325 |
| 50 | 19325 < BS <= 22624 |
| 51 | 22624 < BS <= 26487 |
| 52 | 26487 < BS <= 31009 |
| 53 | 31009 < BS <= 36304 |
| 54 | 36304 < BS <= 42502 |
| 55 | 42502 < BS <= 49759 |
| 56 | 49759 < BS <= 58255 |
| 57 | 58255 < BS <= 68201 |
| 58 | 68201 < BS <= 79846 |
| 59 | 79846 < BS <= 93479 |
| 60 | 93479 < BS <= 109439 |
| 61 | 109439 < BS <= 128125 |
| 62 | 128125 < BS <= 150000 |
| 63 | BS > 150000 |

### EXAMPLE 1

For example it is assumed that out of the four LCGs, two LCGs have low data which can be signaled with the Rel.8/9 BSR table. Other two LCGs have high data which require the additional table to transmit the BSR. The BSR information is transmitted to the eNodeB using two MAC CEs: Rel.8/9 Long BSR and extended short BSR.

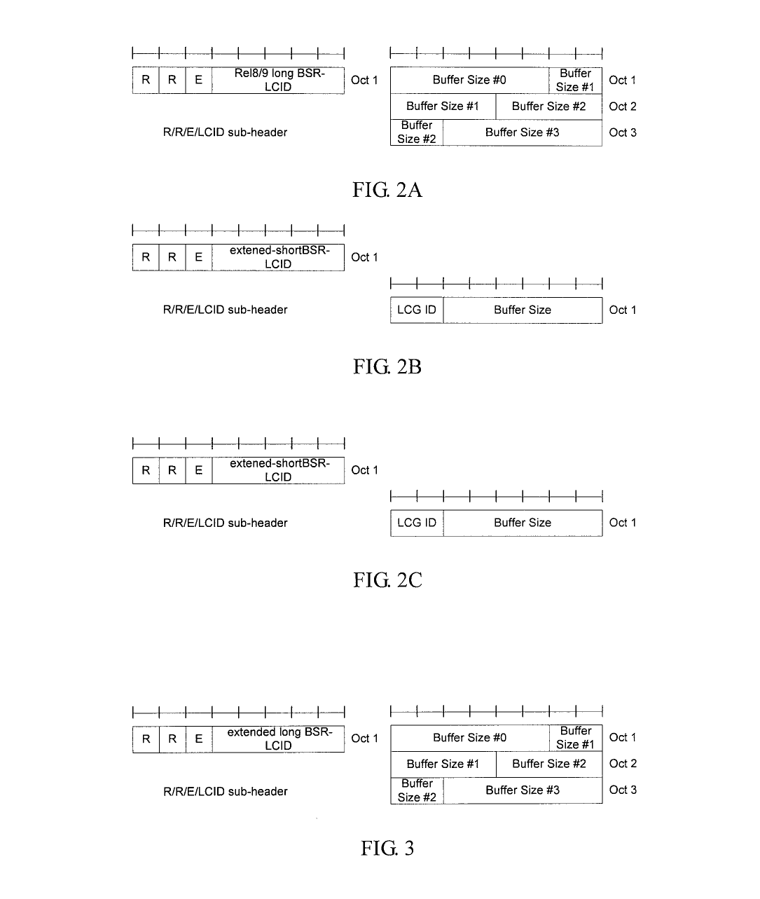

The format is shown in FIG. 2. First the Rel.8/9 long BSR format is used to inform the eNodeB of long BSR. The LCGs which has high data rate indicates the index 63 (BS>150000 Bytes) in the MAC CE, for example, #2 and #3 LCG have a buffer size larger than 150000 Bytes, so that the index of the Buffer Size #2 and Buffer Size #3 are both 63. Secondly the UE transmit the BSR for the two LCGs which have high data using the additional BSR table. For example, in the short BSR in FIG. 2B, the LCG ID can be #2 and the Buffer Size uses the index refer to the additional BSR table, while the LCG ID in the short BSR in FIG. 2C can be #3 and the Buffer Size uses the index refer to the additional BSR table. Note that new LCID extended-shortBSR-LCID is used to indicate that the additional BSR table is used. The LCG ID (as in Rel.8/9) is used to identify the corresponding logical channel group in the extended short BSR MAC CE. Index 63 in the first MAC CE (Rel.8/9 long BSR) is signaled the additional BSR information which are transmitted following the long BSR. Note that all three BSRs, to be specific, the one long BSR and two short BSRs can be combined and transmitted in the same MAC PDU.

Those skilled in the art can understand that such BSR format apply to all the situations such as the BSR for one LCG referring to the Rel. 8/9 table needs to be transmitted and the BSR for three LCGs referring to the additional BSR table need to be transmitted, etc.

### EXAMPLE 2

For example assume that all four LCGs have high data requiring additional BSR table. In this case it is inefficient to transmit Rel.8/9 long BSR together with four extended short BSRs. Therefore, the new LCID is allocated to indicate the extended long BSR as shown in the FIG. 3. To be specific, the

Buffer Size for all the four LCGs #0,#1,#2 and #3 use the index that refer to the additional BSR table to indicate the buffer size.

### EXAMPLE 3

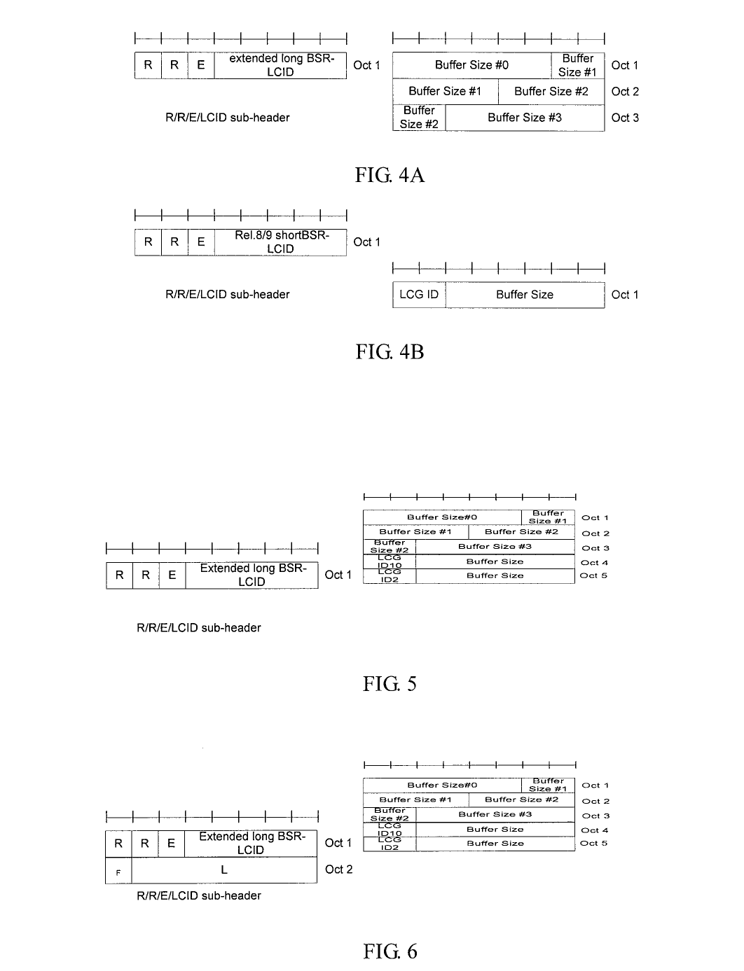

Assume that three out of four LCGs require transmission of extended BSR. In this case, extended long BSR is sent first and the LCG which has low data indicated by the lowest index of the additional BSR table, for example 0, which is BS<150000. This is used signal the following BSR which uses Rel.8/9 short BSR. This would allow for efficient transmission of BSR. The format is shown in FIG. 4.

In a preferred embodiment of the present invention, taking the overhead into consideration, the amount of the LCG(s) with larger buffer size can be used to determine the order for the transmission of the extended BSR or the Rel. 8/9 BSR, i.e., whether the extended (Rel. 10) BSR or the Rel. 8/9 BSR should be transmitted first.

For example, when the amount of LCG with smaller buffer size is larger than that of the LCG with larger buffer size, BSR for the LCG with smaller buffer size is first transmitted with Rel. 8/9 long BSR and the BSR for the LCG with larger buffer size is then transmitted with short BSR with a new LCID(i.e., Example 1 shown in FIG. 2A-2C), so that the overhead for MAC sub-header can be reduced compared with the case in Example 3; when the amount of LCG with larger buffer size is larger than that of the LCG with smaller buffer size, BSR for the LCG with larger buffer size is first transmitted with long BSR with a new LCID (i.e., Example 3 shown in FIG. 4A-4B)and the BSR for the LCG with smaller buffer size is then transmitted with Rel. 8/9 short BSR.

### EXAMPLE 4

Solution A:

The scenario is the same as in Example 1. In order to reduce the overhead due to the transmission of additional sub-header for the extended short BSR, the method proposes a new MAC CE format for the transmission of the combined Rel.8/9 BSR Table and additional BSR table information. One new LCID is used to identify the new MAC CE format. The format is shown in FIG. 5. First the buffer status according to Rel.8/9 BSR table and long BSR order is defined. Then the extended BSR for the required LCGs is to defined using the short BSR format. In this solution only one BSR MAC CE is sent.

In other word, in FIG. 5, the Extended long BSR-LCID in the MAC sub-header indicates that a new BSR format is used, and the buffer size index in the long BSR referring to the Rel. 8/9 BSR table is transmitted first while the buffer size index in the short BSR subsequent to the long BSR referring to the additional BSR table is transmitted second.

Further, the length of the MAC CE is variable and it depends on the number of LCGs requiring extended BSR transmission. The length of the MAC CE can be indicated by the two reserve bits (R) of the MAC sub-header. Or alternatively the length of the MAC CE can be indicated with the L field of the MAC sub-header as shown in FIG. 6. The MAC sub-header shown in FIG. 6 used to indicate the size of the MAC SDU in Rel.8/9 data transmission, but not for the transmission of control element, while in Rel. 10, the MAC sub-header can be used for MAC CE with the L field used to indicate the length of the MAC CE since the length of the MAC CE in Rel. 10 can be variable.

Solution B:

Another alternative of this solution is described below. The method proposes a new MAC CE format for the transmission of the combined Rel.8/9 BSR Table and additional BSR table information. One new LCID is used to identify the new MAC CE format. The format is shown in FIG. 8. First the buffer status according to the additional BSR table and long BSR order is defined. Then the Rel.8/9 BSR for the required LCGs is defined using the short BSR format. In this solution only one BSR MAC CE is sent.

In other word, in FIG. 8, the Extended long BSR-LCID in the MAC sub-header indicates that a new BSR format is used, and the buffer size index in the long BSR referring to the additional BSR table is transmitted first while the buffer size index in the short BSR subsequent to the long BSR referring to the Rel. 8/9 BSR is transmitted second.

In a preferred embodiment of the present invention, taking the overall to bytes of MAC CE into consideration, the amount of the LCG(s) with larger buffer size can be used to determine the order for the transmission of the extended BSR or the Rel. 8/9 BSR, i.e., whether the extended (Rel. 10) BSR or the Rel. 8/9 BSR should be transmitted first.

For example, when the amount of LCG with smaller buffer size is larger than that of the LCG with larger buffer size, BSR for the LCG with smaller buffer size is first transmitted with Rel. 8/9 long BSR and the BSR for the LCG with larger buffer size is then transmitted with short BSR (i.e., Solution A shown in FIG. 5), so that the overall bytes for MAC CE can be reduced compared with Solution B shown in FIG. 8; when the amount of LCG with larger buffer size is larger than that of the LCG with smaller buffer size, BSR for the LCG with larger buffer size is first transmitted with long BSR (i.e., Solution B shown in FIG. 8) and the BSR for the LCG with smaller buffer size is then transmitted with Rel. 8/9 short BSR (i.e., Solution A shown in FIG. 5).

Solution C:

Another alternative of new long BSR MAC CE format is shown in FIG. 7. Here the new LCID in sub-header indicate the new long BSR format. The LCG which BSR belong to is identified by the order in the MAC CE content. 6 bits is used to indicate the buffer size. The first two bits of each byte indicate the BSR table. For example 00 indicates the Rel.8/9 BSR table while 01 indicates the additional BSR table.

For the short BSR, this method can also be used. The table index can be indicated by the reserve bit (one bit is for two tables) of the MAC sub-header.

Besides, if the BSR for all the LCG needs to report have the buffer size smaller than the predetermined value, then Rel. 8/9 BSR table is sufficient, which falls into the scope of the prior art and such situation is not given in details for simplicity.

Then, in step S102, the UE 1 reports the generated BSR to the eNodeB 2.

Then, in step S103, the eNodeB 2 receives the BSR from UE 1.

In step S104, the eNodeB 2 determines whether the received BSR is the BSR for at least one LCG with a larger buffer size according to the LCID or related bits in the MAC control element, for example the table ID illustrated in the scenario shown in FIG. 7, derived from the received BSR, said LCG with a larger buffer has a buffer size larger than a predetermined value.

In step S105, if the extended BSR is used, the eNodeB 2 obtains the buffer size according to the BSR and at least one additional table and schedules UL resources for the UE 1 according to the buffer size, and the at least one additional table indicates the buffer status corresponding to higher data rates than Rel. 8/9 table.

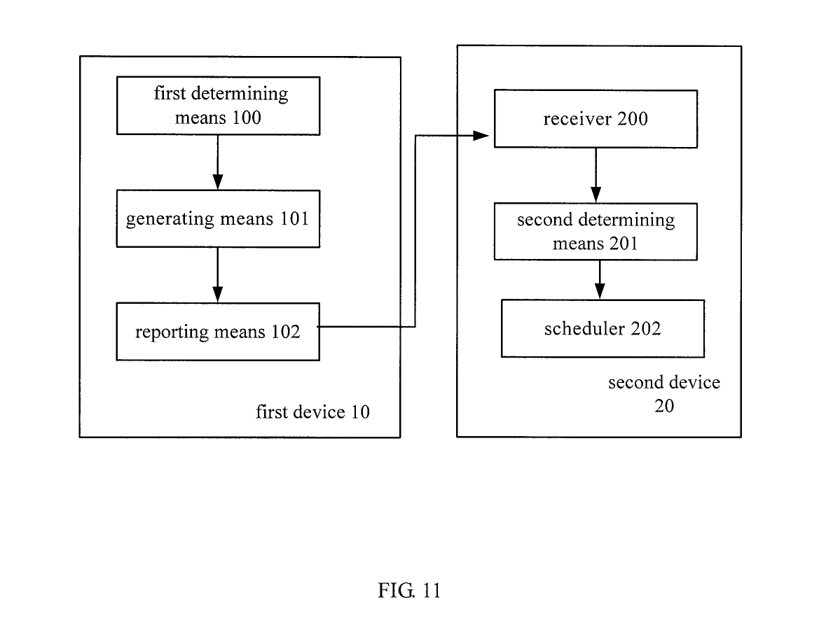

FIG. 11 shows a block diagram of devices according to an embodiment of the present invention.

The first device 10 shown in FIG. 11 can be configured in the UE 1 shown in FIG. 9 and FIG. 10, while the second device 20 shown in FIG. 12 can be configured in the eNodeB 2 shown in FIG. 9 and FIG. 10.

The first device 10 comprises a first determining means 100, a generating means 101 and a reporting means 102, and the second device 20 comprises a receiver 200, a second determining means 201 and a scheduler 202.

First, in step S100, the first determining means 100 determines whether BSR for at least one LCG with larger buffer size needs at least one additional table to be reported, and the LCG with higher buffer size has a buffer size larger than a predetermined value.

The UE 1 measures the buffer sizes of the logical channel groups that need to be reported, and the first determining means 100 determines whether at least one LCG with larger buffer size needs at least one additional table to be reported. Those skilled in the art can understand that since it has already been regulated in LTE Rel. 8/9 that the biggest index 63 of the buffer size levels for BSR in the Rel. 8/9 represent BS>150000, the predetermined value for the first additional table can be set to 150000. Of course, the predetermined value for the second or other additional table(s) if needed can be set by the telecommunication network operators and service provider based on the actual UL data rate of the UE. Such additional table(s) is used to provide not only more accurate granularity, but also higher data amount.

Then, if the BSR for at least one LCG with larger buffer size needs to be reported, the generating means 101 generates the BSR for the at least one LCG with higher buffer size with an index referring to the at least one additional table, and the at least one additional table indicates the buffer status corresponding to higher data rates than Rel. 8/9 table. The details of the process executed by the generating means 101 are described below with the following examples.

In this invention, only the existing Rel. 8/9 BSR table is shown in the above Table 2, and the additional BSR table(s) is not shown. However, those skilled in the art can understand that the specific design, for example, value and mapping relationship, of the additional BSR table is irrelevant to the core idea of the present invention thus is omitted for simplicity.

### EXAMPLE 1

For example it is assumed that out of the four LCGs, two LCGs have low data which can be signaled with the Rel.8/9 BSR table. Other two LCGs have high data which require the additional table to transmit the BSR. The BSR information is transmitted to the eNodeB using two MAC CEs: Rel.8/9 Long BSR and extended short BSR.

The format is shown in FIG. 2. First the Rel.8/9 long BSR format is used to inform the eNodeB of long BSR. The LCGs which has high data rate indicates the index 63 (BS>150000 Bytes) in the MAC CE, for example, #2 and #3 LCG have a buffer size larger than 150000 Bytes, so that the index of the Buffer Size #2 and Buffer Size #3 are both 63. Secondly the reporting means 102 reports the BSR for the two LCGs which have high data using the additional BSR table. For example, in the short BSR in FIG. 2B, the LCG ID can be #2 and the Buffer Size uses the index refer to the additional BSR table, while the LCG ID in the short BSR in FIG. 2C can be #3 and the Buffer

Size uses the index refer to the additional BSR table. Note that new LCID extended-shortBSR-LCID is used to indicate that the additional BSR table is used. The LCG ID (as in Rel.8/9) is used to identify the corresponding logical channel group in the extended short BSR MAC CE. Index 63 in the first MAC CE (Rel.8/9 long BSR) is signaled the additional BSR information which are transmitted following the long BSR. Note that all three BSRs, to be specific, the one long BSR and two short BSRs can be combined and transmitted in the same MAC PDU.

Those skilled in the art can understand that such BSR format apply to all the situations such as the BSR for one LCG referring to the Rel. 8/9 table needs to be transmitted and the BSR for three LCGs referring to the additional BSR table need to be transmitted, etc.

### EXAMPLE 2

For example assume that all four LCGs have high data requiring additional BSR table. In this case it is inefficient to transmit Rel.8/9 long BSR together with four extended short BSRs. Therefore, the new LCID is allocated to indicate the extended long BSR as shown in the FIG. 3. To be specific, the Buffer Size for all the four LCGs #0,#1,#2 and #3 use the index that refer to the additional BSR table to indicate the buffer size.

### EXAMPLE 3

Assume that three out of four LCGs require transmission of extended BSR. In this case, extended long BSR is sent first and the LCG which has low data indicated by the lowest index of the additional BSR table, for example 0, which is BS<150000. This is used signal the following BSR which uses Rel.8/9 short BSR. This would allow for efficient transmission of BSR. The format is shown in FIG. 4.

In a preferred embodiment of the present invention, taking the overhead into consideration, the amount of the LCG(s) with larger buffer size can be used to determine the order for the transmission of the extended BSR or the Rel. 8/9 BSR, i.e., whether the extended (Rel. 10) BSR or the Rel. 8/9 BSR should be transmitted first.

For example, when the amount of LCG with smaller buffer size is larger than that of the LCG with larger buffer size, BSR for the LCG with is smaller buffer size is first transmitted by the reporting means 102 with Rel. 8/9 long BSR and the BSR for the LCG with larger buffer size is then transmitted with short BSR with a new LCID(i.e., Example 1 shown in FIG. 2A-2C), so that the overhead for MAC sub-header can be reduced compared with the case in Example 3; when the amount of LCG with larger buffer size is larger than that of the LCG with smaller buffer size, BSR for the LCG with larger buffer size is first transmitted with long BSR with a new LCID (i.e., Example 3 shown in FIG. 4A-4B)and the BSR for the LCG with smaller buffer size is then transmitted with Rel. 8/9 short BSR.

### EXAMPLE 4

Solution A:

The scenario is the same as in Example 1. In order to reduce the overhead due to the transmission of additional sub-header for the extended short BSR, the method proposes a new MAC CE format for the transmission of the combined Rel.8/9 BSR Table and additional BSR table information. One new LCID is used to identify the new MAC CE format. The format is shown in FIG. 5. First the buffer status according to Rel.8/9 BSR table and long BSR order is defined. Then the extended BSR for the required LCGs is defined using the short BSR format. In this solution only one BSR MAC CE is sent.

In other word, in FIG. 5, the Extended long BSR-LCID in the MAC sub-header indicates that a new BSR format is used, and the buffer size index in the long BSR referring to the Rel. 8/9 BSR table is transmitted first while the buffer size index in the short BSR subsequent to the long BSR referring to the additional BSR table is transmitted second.

Further, the length of the MAC CE is variable and it depends on to the number of LCGs requiring extended BSR transmission. The length of the MAC CE can be indicated by the two reserve bits (R) of the MAC sub-header. Or alternatively the length of the MAC CE can be indicated with the L field of the MAC sub-header as shown in FIG. 6. The MAC sub-header shown in FIG. 6 used to indicate the size of the MAC SDU in Rel.8/9 data transmission, but not for the transmission of control element, while in Rel. 10, the MAC sub-header can be used for MAC CE with the L field used to indicate the length of the MAC CE since the length of the MAC CE in Rel. 10 can be variable.

Solution B:

Another alternative of this solution is described below. The method proposes a new MAC CE format for the transmission of the combined Rel.8/9 BSR Table and additional BSR table information. One new LCID is used to identify the new MAC CE format. The format is shown in FIG. 8. First the buffer status according to the additional BSR table and long BSR order is defined. Then the Rel.8/9 BSR for the required LCGs is defined using the short BSR format. In this solution only one BSR MAC CE is sent.

In other word, in FIG. 8, the Extended long BSR-LCID in the MAC sub-header indicates that a new BSR format is used, and the buffer size index in the long BSR referring to the additional BSR table is transmitted first while the buffer size index in the short BSR subsequent to the long BSR referring to the Rel. 8/9 BSR is transmitted second.

In a preferred embodiment of the present invention, taking the overall bytes of MAC CE into consideration, the amount of the LCG(s) with larger buffer size can be used to determine the order for the transmission of the extended BSR or the Rel. 8/9 BSR, i.e., whether the extended (Rel. 10) BSR or the Rel. 8/9 BSR should be transmitted first.

For example, when the amount of LCG with smaller buffer size is larger than that of the LCG with larger buffer size, BSR for the LCG with smaller buffer size is first transmitted with Rel. 8/9 long BSR and the BSR for the LCG with larger buffer size is then transmitted with short BSR (i.e., Solution A shown in FIG. 5), so that the overall bytes for MAC CE can be reduced compared with Solution B shown in FIG. 8; when the amount of LCG with larger buffer size is larger than that of the LCG with smaller buffer size, BSR for the LCG with larger buffer size is first transmitted with long BSR (i.e., Solution B shown in FIG. 8) and the BSR for the LCG with smaller buffer size is then transmitted with Rel. 8/9 short BSR (i.e., Solution A shown in FIG. 5).

Solution C:

Another alternative of new long BSR MAC CE format is shown in FIG. 7. Here the new LCID in sub-header indicate the new long BSR format. The LCG which BSR belong to is identified by the order in the MAC CE content. 6 bits is used to indicate the buffer size. The first two bits of each byte indicate the BSR table. For example 00 indicates the Rel.8/9 BSR table while 01 indicates the additional BSR table.

For the short BSR, this method can also be used. The table index can be indicated by the reserve bit (one bit is for two tables) of the MAC sub-header.

Besides, if the BSR for all the LCG needs to report have the buffer size smaller than the predetermined value, then Rel. 8/9 BSR table is sufficient, which falls into the scope of the prior art and such situation is not given in details for simplicity.

Then, the reporting means 102 reports the generated BSR to the eNodeB 2.

Then, the receiver 200 in the eNodeB 2 receives the BSR from UE 1.

Then, the second determining means 201 determines whether the received BSR is the BSR for at least one LCG with a larger buffer size according to the LCID or related bits in the MAC control element, for example the table ID illustrated in the scenario shown in FIG. 7, derived from the received BSR, said LCG with a larger buffer has a buffer size larger than a predetermined value.

If the extended BSR is used, the scheduler 202 obtains the buffer size according to the BSR and at least one additional table and schedules UL resources for the UE 1 according to the buffer size, and the at least one additional table indicates the buffer status corresponding to higher data rates than Rel. 8/9 table.

Those skilled in the art can understand that the Rel. 8/9 table and the additional table are synchronized at both the UE 1 and eNodeB 2 side during the network configuration stage. For example, the Rel.8/9 table and the additional table are sent to both the UE 1 and the eNodeB 2 with the Layer 3 signaling, so that the eNodeB 2 has the same interpretation of what the index in the BSR MAC control element represents as that of the UE 1.

The embodiments of the present invention have been described above. It is understandable by those skilled in the art that the present invention is not limited to specific system, device or protocol, and various modifications or amendments can be made without departing from the scope and spirit of the scope of the attached claims.

Those skilled in the art can understand that the above-described embodiments are for purpose of illustration only, and not construed as limitation of the invention. The present invention is not limited to these embodiments. All technical solutions which do not depart from the spirit of the invention are intended to be included within the scope of the appended claims. Besides, in the claims, any reference signs placed between parentheses shall not be construed as limiting the claim. The word “comprising” does not exclude the presence of elements or steps not listed in the claim or in the description. The word “a” or “an” preceding an element does not exclude the presence of a plurality of such elements. In device that includes a plurality of means, one or more functions of the plurality of means can be implemented by one hardware or software module; the words “first”, “second” and “third” only represent name, and do not mean specific order.

1. A method in a UE of reporting BSR to an eNodeB dominating said UE comprising:
determining whether BSR for at least one LCG with larger buffer size needs to be reported, said LCG with larger buffer size having a buffer size larger than a predetermined value and said larger buffer size needs at least one additional table for report, said at least one additional table indicating the buffer status corresponding to a larger buffer size than Rel. 8/9 table;
if the BSR for said at least one LCG with larger buffer size needs to be reported, generating the BSR for said at least one LCG with larger buffer size with an index referring to said at least one additional table;
reporting said generated BSR to said eNodeB.

2. A method according to claim 1, wherein said generating further comprises:
allocating a new LCID in the MAC sub-header for indicating the use of said at least one additional table.

3. A method according to claim 1, wherein if BSR for at least one LCG with a smaller buffer size together with said at least one LCG with larger buffer size need to be reported, said LCG with a smaller buffer size having a buffer size smaller than or equal to a predetermined value and said smaller buffer size needs Rel. 8/9 table for report, said generating further comprises:
generating the BSR for said at least one LCG with larger buffer size with said index referring to said at least one additional table and the BSR for said at least one LCG with smaller buffer size with an index referring to said Rel. 8/9 table.

4. A method according to claim 3, wherein if at least two MAC control elements are used for reporting said BSR, the method further comprises the following before said generating:
obtaining the amount of said at least one LCG with larger buffer size;
said generating further comprises:
determining the order of the BSR according to said amount of said at least one LCG with larger buffer size;
generating the BSR for said at least one LCG with larger buffer size with said index referring to said at least one additional table and the BSR for said at least one LCG with smaller buffer size with said index referring to said Rel.8/9 table according to said order of the BSR.

5. A method according to claim 3, wherein if one MAC control element only is used for reporting said BSR and the length of said MAC control element is variable, the method further comprises the following before said generating:
obtaining the amount of said at least one LCG with larger buffer size;
said generating further comprises:
determining the length of said MAC control element according to said amount of said at least one LCG with larger buffer size;
using the reserved bits in MAC sub-header or the L field of the MAC sub-header to indicate said length of said MAC control element.

6. A method according to claim 5, wherein, said step
generating further comprises:
determining the order of the BSR according to said amount of said at least one LCG with larger buffer size;
generating the BSR for said at least one LCG with larger buffer size with said index referring to said at least one additional table and the BSR for said at least one LCG with smaller buffer size with said index referring to said Rel. 8/9 table according to said order of the BSR.

7. A method according to claim 3, wherein if one MAC control element only is used for reporting said BSR, said generating further comprises:
using at least one bit in each byte of the MAC control element to indicate whether said Rel. 8/9 table or said at least one additional table is referred to by the index in the BSR and the new LCID in the sub-header to indicate a new long BSR format.

8. A method in an eNodeB dominating a UE of processing BSR from said UE comprising:
receiving BSR from said UE;
determining whether said received BSR is the BSR for at least one LCG with larger buffer size according to the LCID or related bits in the MAC control element derived from said received BSR, said LCG with larger buffer size having a buffer size larger than a predetermined value and said larger buffer size needs at least one additional table for report, said at least one additional table indicating the buffer status corresponding to a larger buffer size than Rel. 8/9 table;
if said BSR for at least one LCG with larger buffer size is used, obtaining the buffer size according to said BSR and at least one additional table, and scheduling UL resources for said UE according to said buffer size.

9. A first device in a UE of reporting BSR to an eNodeB dominating said UE comprising:
a first determining means configured to determine whether BSR for at least one LCG with larger buffer size needs to be reported, said LCG with larger buffer size having a buffer size larger than a predetermined value and said larger buffer size needs at least one additional table for report;
a generating means configured, if the BSR for said at least one LCG with larger buffer size needs to be reported, to generate the BSR for said at least one LCG with larger buffer size with an index referring to said at least one additional table, said at least one additional table indicating the buffer status corresponding to larger buffer size than Rel. 8/9 table;
reporting means configured to report said generated BSR to said eNodeB.

10. A first device according to claim 9, wherein said generating means further configured to:
allocate a new LCID in the MAC sub-header for indicating the use of said at least one additional table.

11. A first device according to claim 9, wherein if BSR for at least one LCG with a smaller buffer size together with said at least one LCG with larger buffer size need to be reported, said LCG with a smaller buffer size having a buffer size smaller than or equal to a predetermined value and said smaller buffer size needs Rel. 8/9 table for report, said generating means further configured to:
generate the BSR for said at least one LCG with larger buffer size with said index referring to said at least one additional table and the BSR for said at least one LCG with smaller buffer size with an index referring to said Rel. 8/9 table.

12. A first device according to claim 11, wherein if at least two MAC control elements are used for reporting said BSR, the first device further comprises:
an obtaining means configured to obtain the amount of said at least one LCG with larger buffer size;
said generating means further configured to:
determine the order of the BSR according to said amount of said at least one LCG with larger buffer size;
generate the BSR for said at least one LCG with larger buffer size with said index referring to said at least one additional table and the BSR for said at least one LCG with smaller buffer size with said index referring to said Rel.8/9 table according to said order of the BSR.

13. A first device according to claim 11, wherein if one MAC control element only is used for reporting said BSR and the length of said MAC control element is variable, the first device further comprises:
an obtaining means configured to obtain the amount of said at least one LCG with larger buffer size;
said generating means further configured to:
determine the length of said MAC control element according to said amount of said at least one LCG with larger buffer size;
use the reserved bits in MAC sub-header or the L field of the MAC sub-header to indicate said length of said MAC control element.

14. A first device according to claim 13, wherein, said generating means further configured to:
determine the order of the BSR according to said amount of said at least one LCG with larger buffer size;
generate the BSR for said at least one LCG with larger buffer size with said index referring to said at least one additional table and the BSR for said at least one LCG with smaller buffer size with said index referring to said Rel. 8/9 table according to said order of the BSR.

15. A second device in an eNodeB dominating a UE of processing BSR from said UE comprising:
a receiver configured to receive BSR from said UE;
a second determining means configured to determine whether said received BSR is the BSR for at least one LCG with larger buffer size according to the LCID or related bits in the MAC control element derived from said received BSR, said LCG with larger buffer size having a buffer size larger than a predetermined value;
a scheduler configured, if said BSR for at least one LCG with larger buffer size is used, to obtain the buffer size according to said BSR and at least one additional table, and to schedule UL resources for said UE according to said buffer size, said at least one additional table indicating the buffer status corresponding to higher data rates than Rel. 8/9 table.
